(19) United States
(12) Patent Application Publication
(10) Pub. No.: US 2021/0281827 A1
(43) Pub. Date: Sep. 9, 2021

(54) THREE-DIMENSIONAL (3D) SPACE VISION CORRECTION PRESCRIPTION FOR DISPLAYS

(71) Applicant: D'Annunzio Investments Group, LLC, South Plainfield, NJ (US)

(72) Inventors: James D'Annunzio, Warren, NJ (US); Anthony D'Annunzio, Beverly Hills, CA (US)

(73) Assignee: D'Annunzio Investments Group, LLC, South Plainfield, NJ (US)

(21) Appl. No.: 17/192,119

(22) Filed: Mar. 4, 2021

Related U.S. Application Data
(60) Provisional application No. 62/984,902, filed on Mar. 4, 2020.

(51) Int. Cl. H04N 13/398; H04N 13/31; H04N 13/366; G02B 30/30

(52) U.S. Cl. CPC H04N 13/398; G02B 30/30; H04N 13/366; H04N 13/31

(57) ABSTRACT

Described is a three-dimensional (3D) space vision correction prescription system for displays. The system includes a 3D parallax barrier screen having an opaque layer with a series of slits formed therethrough. The barrier screen is formed to position over a device display screen. Also included is a software application that, upon receiving a distance between a viewer and the barrier screen, progressively performs cross-pixel manipulation. In doing so, the display device alters the image as displayed by the left and right pixels until the viewer indicates that the image is clear to the viewer, thereby performing image correction simulation.

### CROSS-REFERENCE TO RELATED APPLICATIONS

This is a non-provisional application of U.S. Provisional Application No. 62/984,902, filed on Mar. 04, 2020, the entirety of which is incorporated herein by reference.

### BACKGROUND OF THE INVENTION

### (1) Field of Invention

The present invention relates to a system for vision correction and, more particularly, to a system that includes a software application and barrier screen for generation of a display image that can be seen clearly without the need for prescription lenses.

### (2) Description of Related Art

Display screens are created to display the text, image, etc., in a clear and unadulterated form. In other words, the entire point of a display screen, such as that found on a mobile device, is to provide a clean image that is unblurred and clear to the viewer. While desirable, a problem exists for some viewers that have eyesight abnormalities. Eyesight abnormalities are often correctable through corrective glasses or other eyewear that correct the user's inherent vision to be able to view the clean image on the display. While operable, one can imagine that it is desirable to view a display screen without the need for corrective eyewear. However, without corrective eyewear, those with eyesight abnormalities only see blurred or otherwise adversely affected imagery.

Thus, a continuing need exists for a system that modifies a display image to allow a viewer to view the image clearly without corrective eyewear.

### SUMMARY OF INVENTION

This disclosure is directed system that utilizes a mobile device in conjunction with a barrier screen and software application for generation of a display image that can be seen clearly without the need for prescription lenses. The device (e.g., smart phone, tablet computer, laptop, desktop computer with attached monitor, etc.) includes executable instructions to cause the display device to perform several operations as described herein to modify a display of the device and, in doing so, generate a vision prescription.

In some aspects, the present disclosure is directed to three-dimensional (3D) space vision correction prescription for displays, comprising a three-dimensional (3D) parallax barrier screen. The 3D parallax barrier screen includes an opaque layer with a series of slits formed therethrough.

In another aspect, the 3D space vision correction prescription for displays further includes an executable software application encoded on a non-transitory computer readable medium. The software application, when executed by one or more processors, is operable for causing one or more processors to perform operations of receiving a distance between a viewer and the 3D parallax barrier screen positioned over a device display screen; displaying an image on the device display screen, the device display screen having a pixel layer with a plurality of left and right eye pixels, with the image being displayed by the left and right eye pixels such that the left and right eye pixels are viewable by the viewer through the slits in the 3D parallax barrier screen; and altering the image as displayed by the left and right pixels until the viewer indicates that the image is clear to the viewer, thereby performing image correction simulation.

In yet another aspect, altering the image as displayed by the left and right pixels includes an operation of performing cross-pixel manipulation by adjusting the left and right 3D display pixels in space coordinates on an x-axis, y-axis and z-axis until the viewer indicates that the image is clear to the viewer.

In another aspect, first and second translucent layers are included to sandwich the opaque layer therebetween. Further, a protective cover layer is affixed with the second translucent layer, the protective cover layer being a polarizer layer.

In yet another aspect, in receiving the distance between a viewer and the 3D parallax barrier screen positioned over a device display screen, the one or more processors receive a manually measured input by a user.

In yet another aspect, in receiving the distance between a viewer and the 3D parallax barrier screen positioned over a device display screen, the one or more processors perform a distance calculation using readings from a sensor attached to the display device.

In another aspect, the present invention includes a method for positioning the barrier screen over a display device screen and then causing the display device to perform the operations as listed herein.

Finally, the present invention also includes a computer program product and a computer implemented method. The computer program product embodies the software application and includes computer-readable instructions stored on a non-transitory computer-readable medium that are executable by a computer having one or more processors, such that upon execution of the instructions, the one or more processors perform the operations listed herein. In some aspects, the one or more processors are embedded within the device, such as within a smart phone, tablet computer, etc., thereby causing the smart phone or display device to perform the operations as described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is an illustration of a device operating the software application and a barrier screen for positioning over the device's display screen to cause the display to be seen clearly by a viewer;

FIG. 2 is cross-sectional, side-view illustration depicting a barrier screen as positioned over the device display screen to generate the images that can be seen clearly by the viewer;

FIG. 3 is an illustration depicting a barrier screen positioned over the device display screen to generate the images that can be seen clearly by the viewer;

FIG. 4 a block diagram depicting the components of a system according to various embodiments of the present invention; and

FIG. 5 is an illustration of a computer program product embodying an aspect of the present invention.

### DETAILED DESCRIPTION

The present disclosure provides a system for vision correction. More specifically, the present disclosure provides a system and barrier screen for generation of a display image that can be seen clearly without the need for prescription lenses. The invention is also directed to a corresponding software application or app that can connect with and operate the display device (e.g., smart phone, tablet computer, laptop, desktop computer with attached monitor, etc.) to generate the image that is seen through the barrier screen. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter-clockwise have been used for convenience purposes only and are not intended to imply any particular fixed direction. Instead, they are used to reflect relative locations and/or directions between various portions of an object.

(1) Specific Details

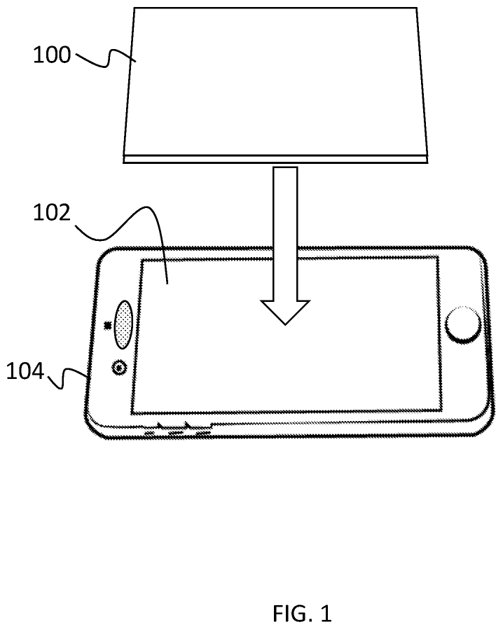

As noted above, this disclosure is directed to a system for vision correction on a display. The system includes a software application (App) that is loaded onto a device (having a display screen) and that can be used to progressively alter a visible image to generate an image that can be seen by a viewer without the need for corrective lenses. Further and as shown in FIG. 1, the invention includes a barrier screen 100, such as a three-dimensional (3D) display parallax barrier, which can be positioned over a traditional device 104 (e.g., mobile phone, tablet computer, etc.) with a display screen 102 to generate the ultimate image. In other words, the barrier screen 100 uses the parallax barrier to enable cross-pixel manipulation to simulate a prescription.

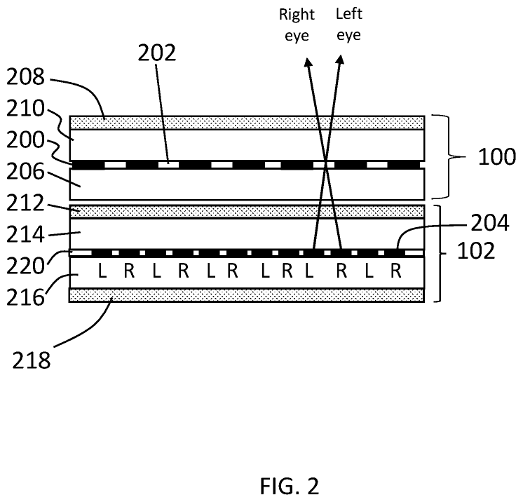

In some aspects, the barrier screen 100 can be incorporated directly into the display device 104. However, in other aspects and as shown in FIG. 1, the parallax barrier screen 100 is a separate device that can be positioned over or otherwise affixed with a traditional display device 104 to alter an image for display to a user. A parallax barrier is a device placed in front of an image source, such as a liquid crystal display (LCD) or any other display, to allow it to show a stereoscopic or multiscopic image without the need for the viewer to wear three-dimensional glasses. For further understanding, FIG. 2 provides a cross-sectional view illustration of the barrier screen 100 as positioned over the display device 104 and its display screen 102. Importantly, the barrier screen 100 includes an opaque layer 200 with a series of precisely spaced slits 202, allowing each eye to see a different set of pixels 204. In some aspects, the opaque layer 200 is sandwiched between first and second translucent layers 206 and 210. The first and second translucent layers 206 and 210 provide spacing and are formed of any suitable material to allow imagery or light to pass therethrough, non-limiting examples of which include glass and acrylic. Desirably, a protective cover layer 208 is included. The protective cover layer 208, formed of acrylic or any other suitable material, includes a polarizer to improve visibility when looking through the barrier screen 100.

Also shown is a cross-sectional view of a typical 3D display 102. It should be understood that the display screen 102 as depicted is provided for illustrative purposes only and that the present invention, including the barrier screen 100, can be applied to a variety of different display screens. In this example, the display screen 102 includes a bottom polarizer layer 218 that holds a glass layer 216 against the pixels or pixel layer 220. A second glass layer 214 is sandwiched between a top polarizer layer 212 and the pixel layer 220. As shown and as described above, the pixels 204 in the pixel layer 220 provide imagery, such that when activated (e.g., turned on, etc.), the barrier screen 100 with its series of spaced slits 202 allow each eye to see a different set of pixels 204 in the pixel layer 220.

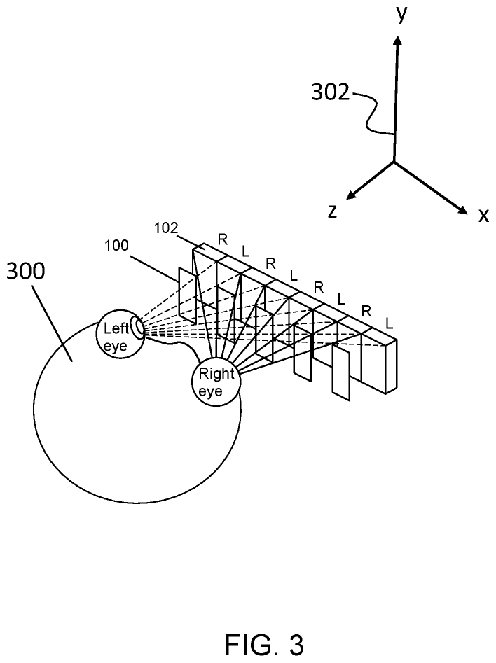

The invention is further illustrated in FIG. 3. As shown, the barrier screen 100 (e.g., 3D display parallax barrier) conveys depth perception to the viewer 300 and combines the optical axis to simulate a vision correction prescription for the viewer of the 3D display 102 to see the screen clearly without the need for prescription lenses. The 3D display screen 102 resolution display canvas is defined in X (width) and Y (length) via pixels.

The distance between the barrier screen 100 and viewer 300 is calculated via a direct to measure instrument (e.g., a measuring tape, etc.) and entered into the system or device by manual entry or, through use of a distance calculation using readings from a sensor (e.g., camera, lidar, etc.) attached to the display device 104 that is calculated using an internal software calculation as understood by those skilled in the art.

In operation, the viewer 300 completes a series of vision exercises. With each stage, the App alters the image that is displayed by the display screen 102 such that the 3D display parallax barrier screen 100 adjusts the displayed image via pixel manipulation within the display screen 102 canvas. The viewer 300 performs the test until their display is clear to their particular vision. Each exercise defines the display's horizontal, vertical, convergence distance, and vertical field-of-view degree, which is managed by the device's internal software (App) to continuously optimize the viewer's correction while preserving the normal operation of the display 102.

The method of the present disclosure uses the 3D display barrier screen 100, which conveys depth perception to the viewer 300, and combines the optical axis to simulate a vision correction prescription for the viewer 300 of the 3D display to see the display screen 102 clearly without the need for prescription lenses. Any suitable method can be used to alter the pixels so that they become clear to the viewer when seen through the barrier screen 100. The calculation equations utilizes the parallax barriers, and the distance between pixels and the parallax within a 3D Space to create a refraction that simulates the vision correction. Thus, the system or display device performs cross-pixel manipulation by adjusting the left and right pixels in space coordinates on an x-axis, y-axis and z-axis 302 until the viewer 300 indicates that the image is clear to the viewer 300.

Below is an example of the pixel horizontal and vertical pixelization changes that can be made to tune to display 102 to provide for clarity to the viewer 300. The formula variables are provided below with a corresponding description. The following variables are used as an array. In other words, the variables are all used in order from num_horizontal_views to view_resolution_y_pixels. In this non-limiting example, the following variables are used to simulate the correction of vision:
int num_horizontal_views,
int num_vertical_views,
float system_disparity_in_pixels,
float baseline_scaling,
float convergence_distance,
float vertical_field_of_view_degrees,
float near, float far,
int view_resolution_x_pixels,
int view_resolution_y_pixels).

With the values within an array of which populates the above values: {(1, 0, 0, 0), (0, 1, 0, 0), (0, 0, 1, 0), (transX, transY, transZ, 1)}.

As used above, Int, short for “integer,” which is a fundamental variable type built into a compiler and used to define numeric variables holding whole numbers. As understood by those skilled in the art, “float” is a shortened term for “floating point.” By definition, it's a fundamental data type built into the compiler that's used to define numeric values with floating decimal points.

Definitions of the above variables are as follows:
um_horizontal_views and num_vertical_views: adjusts the view for 3D rendering.

system_disparity_in_pixels: a value retrieved from the display size.

baseline scaling: This is a scalar for how far beyond the system disparity is from the viewer, taking the vision text which the value scales between 1.0 to 2.0.

convergence_distance: Objects between near and convergence_distance will appear to pop out of the screen, while objects between convergence_distance and far will appear to fall into the screen.
view_resolution_x_pixels and view resolution_y_pixels: The size of each view will render into vision and are a value smaller than the resolution of the screen based on orientation.

It should be noted that the method or process does not operate on a traditional mathematical formula equation. Instead, the logic is applied via the coding shared with the variables and values based on viewer selections which then adjust the display for vision correction until a viewer indicates that the image is clear to them. The pixels are adjusted via process which controls the hardware (i.e., device display screen 102) that displays the image through the parallax display (i.e., the barrier screen 100). The process adjusts the values until the vision is corrected. For example, step one is a baseline number at zero, with each value then being adjusted until the desired correction is achieved (similar to an eye exam procedure).

In operation, once the distance is defined, the viewer completes a series of vision exercises. For example, a pair of images are displayed to the user, with the user asked to select if the first or second image is more clear, similar to an eye exam by an optometrist. The system then continues to provide a series of stages of test images in which the pixels are altered, with the user selecting the image that is most clear to them. With each stage the 3D display parallax barrier adjusts via pixel manipulation within the display screen 102 canvas. The viewer performs the test until their display is clear to their vision.

Each exercise defines the display's horizontal, vertical, convergence distance, vertical field of view degree which is managed by the device's internal software (App) to continuously optimize the viewer's correction while preserving the normal operation of the display.

The software App, in one aspect, is embodied as computer-readable instructions stored on any compatible non-transitory computer-readable medium. The term “instructions” as used with respect to this invention generally indicates a set of operations to be performed on a computer or computing hardware within the controlling device, and may represent pieces of a whole program or individual, separable, software modules. Non-limiting examples of “instruction” include computer program code (source or object code) and “hard-coded” electronics (i.e. computer operations coded into a computer chip). The “instruction” is stored on any non-transitory computer-readable medium, such as in the memory of a computer or on a server, etc. In some aspects, the instructions can be downloaded or otherwise loaded onto the related device (e.g., mobile phone, tablet computer, etc.). For example, the instructions can be stored on an internet accessible server (such as an app store), from which they can be downloaded onto or otherwise loaded onto the device. The instructions are executable, such that once loaded onto the device, the App can be opened and operated to cause the device to operate as a vision correction system and to perform the operations described herein.

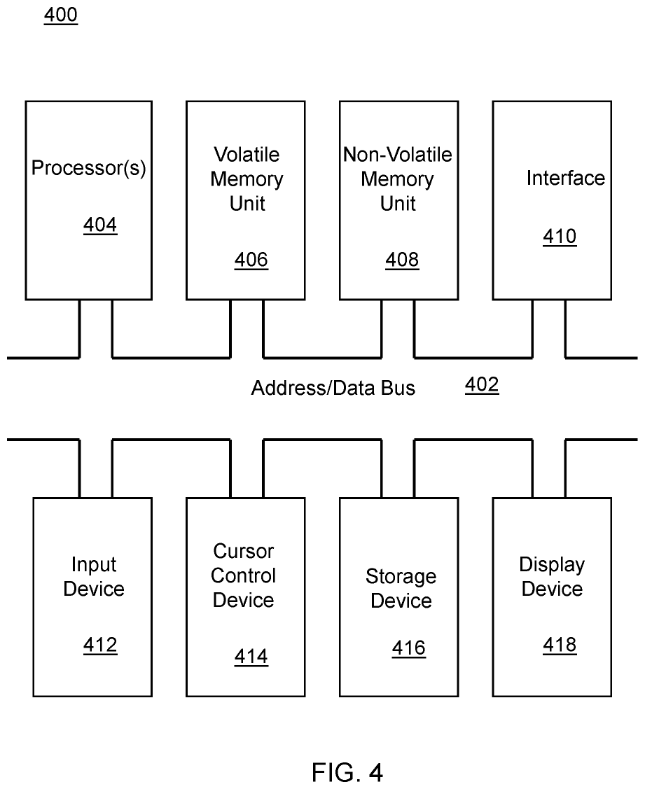

The vision correction system is typically in the form of a computer system operating software or in the form of a “hard-coded” instruction set. This system may be incorporated into a wide variety of devices that provide different functionalities. A block diagram depicting an example of a vision correction system (i.e., computer system 400) of the present invention is provided in FIG. 4. The computer system 400 is configured to perform calculations, processes, operations, and/or functions associated with a program or algorithm. In one aspect, certain processes and steps discussed herein are realized as a series of instructions (e.g., software program) that reside within computer readable memory units and are executed by one or more processors of the computer system 400. When executed, the instructions cause the computer system 400 to perform specific actions and exhibit specific behavior, such as described herein. In various aspects, the computer system 400 can be embodied in any device(s) that operates to perform the functions as described herein as applicable to the particular application, such as a desktop computer, a mobile or smart phone, a tablet computer, a computer embodied in a mobile platform, or any other device or devices that can individually and/or collectively execute the instructions to perform the related operations/processes.

The computer system 400 may include an address/data bus 102 that is configured to communicate information. Additionally, one or more data processing units, such as a processor 404 (or processors), are coupled with the address/data bus 402. The processor 404 is configured to process information and instructions. In an aspect, the processor 404 is a microprocessor. Alternatively, the processor 404 may be a different type of processor such as a parallel processor, application-specific integrated circuit (ASIC), programmable logic array (PLA), complex programmable logic device (CPLD), or a field programmable gate array (FPGA) or any other processing component operable for performing the relevant operations.

The computer system 400 is configured to utilize one or more data storage units. The computer system 400 may include a volatile memory unit 406 (e.g., random access memory (“RAM”), static RAM, dynamic RAM, etc.) coupled with the address/data bus 402, wherein a volatile memory unit 406 is configured to store information and instructions for the processor 404. The computer system 400 further may include a non-volatile memory unit 408 (e.g., read-only memory (“ROM”), programmable ROM (“PROM”), erasable programmable ROM (“EPROM”), electrically erasable programmable ROM “EEPROM”), flash memory, etc.) coupled with the address/data bus 402, wherein the non-volatile memory unit 408 is configured to store static information and instructions for the processor 404. Alternatively, the computer system 400 may execute instructions retrieved from an online data storage unit such as in “Cloud” computing. In an aspect, the computer system 400 also may include one or more interfaces, such as an interface 440, coupled with the address/data bus 402. The one or more interfaces are configured to enable the computer system 400 to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology. Further, one or more processors 404 (or devices) can be associated with one or more associated memories, where each associated memory is a non-transitory computer-readable medium. Each associated memory can be associated with a single processor 404 (or device), or a network of interacting processors 404 (or devices).

In one aspect, the computer system 400 may include an input device 412 coupled with the address/data bus 402, wherein the input device 412 is configured to communicate information and command selections to the processor 404. In accordance with one aspect, the input device 412 is an alphanumeric input device, such as a keyboard, that may include alphanumeric and/or function keys. Alternatively, the input device 412 may be an input device other than an alphanumeric input device. In an aspect, the computer system 400 may include a cursor control device 414 coupled with the address/data bus 402, wherein the cursor control device 414 is configured to communicate user input information and/or command selections to the processor 404. In an aspect, the cursor control device 414 is implemented using a device such as a mouse, a track-ball, a track-pad, an optical tracking device, or a touch screen. The foregoing notwithstanding, in an aspect, the cursor control device 414 is directed and/or activated via input from the input device 412, such as in response to the use of special keys and key sequence commands associated with the input device 412. In an alternative aspect, the cursor control device 414 is configured to be directed or guided by voice commands.

In an aspect, the computer system 400 further may include one or more optional computer usable data storage devices, such as a storage device 416, coupled with the address/data bus 402. The storage device 416 is configured to store information and/or computer executable instructions. In one aspect, the storage device 416 is a storage device such as a magnetic or optical disk drive (e.g., hard disk drive (“HDD”), floppy diskette, compact disk read only memory (“CD-ROM”), digital versatile disk (“DVD”)). Pursuant to one aspect, a display device 418 is coupled with the address/data bus 402, wherein the display device 418 is configured to display video and/or graphics. In an aspect, the display device 418 may include a cathode ray tube (“CRT”), liquid crystal display (“LCD”), field emission display (“FED”), plasma display, or any other display device suitable for displaying video and/or graphic images and alphanumeric characters recognizable to a user.

The computer system 400 presented herein is an example computing environment in accordance with an aspect. However, the non-limiting example of the computer system 400 is not strictly limited to being a computer system. For example, an aspect provides that the computer system 400 represents a type of data processing analysis that may be used in accordance with various aspects described herein. Moreover, other computing systems may also be implemented. Indeed, the spirit and scope of the present technology is not limited to any single data processing environment. Thus, in an aspect, one or more operations of various aspects of the present technology are controlled or implemented using computer-executable instructions, such as program modules, being executed by a computer. In one implementation, such program modules include routines, programs, objects, components and/or data structures that are configured to perform particular tasks or implement particular abstract data types. In addition, an aspect provides that one or more aspects of the present technology are implemented by utilizing one or more distributed computing environments, such as where tasks are performed by remote processing devices that are linked through a communications network, or such as where various program modules are located in both local and remote computer-storage media including memory-storage devices.

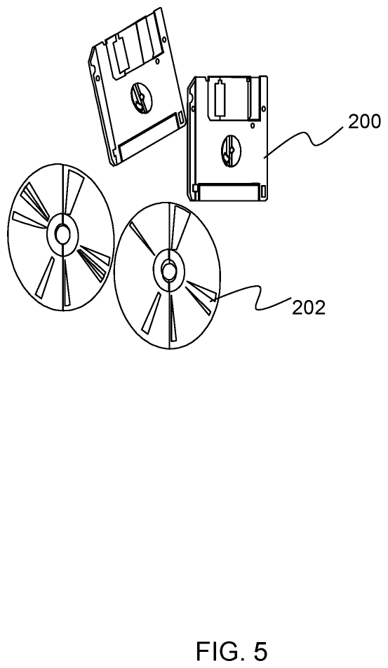

An illustrative diagram of a computer program product (i.e., storage device) embodying the present invention is depicted in FIG. 5. The computer program product is depicted as floppy disk 500 or an optical disk 502 such as a CD or DVD. However, as mentioned previously, the computer program product generally represents computer-readable instructions stored on any compatible non-transitory computer-readable medium. The term “instructions” as used with respect to this invention generally indicates a set of operations to be performed on a computer, and may represent pieces of a whole program or individual, separable, software modules. Non-limiting examples of “instruction” include computer program code (source or object code) and “hard-coded” electronics (i.e.

computer operations coded into a computer chip). The “instruction” is stored on any non-transitory computer-readable medium, such as in the memory of a smart phone, tablet computer, computer or on a floppy disk, a CD-ROM, and a flash drive. In either event, the instructions are encoded on a non-transitory computer-readable medium.

In summary, this disclosure is directed to a device with a barrier screen (that can be positioned over the display device screen) that is operable for progressively modifying the image as displayed to arrive at a vision prescription. This disclosure is also directed to a software application (App) that can be loaded onto a smartphone or other device. The App allows a user to provide inputs into the smartphone to cause the display to progressively change until arriving at a clear screen (at least from the user's perspective), from which the prescription is generated. The App includes all of the relevant instructions that can be loaded onto a smartphone or device to perform the operations described herein. Further, the device includes all of the necessary hardware and components as may be needed to perform the various operations described herein.

Finally, while this invention has been described in terms of several embodiments, one of ordinary skill in the art will readily recognize that the invention may have other applications in other environments. It should be noted that many embodiments and implementations are possible. Further, the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. Further, while particular method steps have been recited in a particular order, the method steps may occur in any desired order and fall within the scope of the present invention.

What is claimed is:

1. A three-dimensional (3D) space vision correction prescription system for displays, comprising:
a three-dimensional (3D) parallax barrier screen, the 3D parallax barrier screen having an opaque layer with a series of slits formed therethrough.

2. The 3D space vision correction prescription system for displays as set forth in claim 1, further comprising:
a software application encoded on a non-transitory computer readable medium, the software application operable for causing one or more processors to perform operations of:
receiving a distance between a viewer and the 3D parallax barrier screen positioned over a device display screen;
displaying an image on the device display screen, the device display screen having a pixel layer with a plurality of left and right eye pixels, with the image being displayed by the left and right eye pixels such that the left and right eye pixels are viewable by the viewer through the slits in the 3D parallax barrier screen; and
altering the image as displayed by the left and right pixels until the viewer indicates that the image is clear to the viewer, thereby performing image correction simulation.

3. The 3D space vision correction prescription system for displays as set forth in claim 2, wherein altering the image as displayed by the left and right pixels includes an operation of performing cross-pixel manipulation by adjusting the left and right pixels in space coordinates on an x-axis, y-axis and z-axis until the viewer indicates that the image is clear to the viewer.

4. The 3D space vision correction prescription system for displays as set forth in claim 3, further comprising first and second translucent layers sandwiching the opaque layer therebetween.

5. The 3D space vision correction prescription system for displays as set forth in claim 4, further comprising a protective cover layer affixed with the second translucent layer, the protective cover layer being a polarizer layer.

6. The 3D space vision correction prescription system for displays as set forth in claim 5, wherein receiving the distance between a viewer and the 3D parallax barrier screen positioned over a device display screen, the one or more processors receive a manually measured input by a user.

7. The 3D space vision correction prescription system for displays as set forth in claim 5, wherein receiving the distance between a viewer and the 3D parallax barrier screen positioned over a device display screen, the one or more processors perform a distance calculation using readings from a sensor attached to the display device.

8. A computer program product for three-dimensional (3D) space vision correction prescription for displays the computer program product comprising:
a non-transitory computer-readable medium having executable instructions encoded thereon, such that upon execution of the instructions by one or more processors, the one or more processors perform operations of:
receiving a distance between a viewer and a 3D parallax barrier screen positioned over a device display screen, the 3D parallax barrier screen having an opaque layer with a series of slits formed therethrough;
displaying an image on the device display screen, the device display screen having a pixel layer with a plurality of left and right eye pixels, with the image being displayed by the left and right eye pixels such that the left and right eye pixels are viewable by the viewer through the slits in the 3D parallax barrier screen; and
altering the image as displayed by the left and right pixels until the viewer indicates that the image is clear to the viewer, thereby performing image correction simulation.

9. The computer program product as set forth in claim 8, wherein altering the image as displayed by the left and right pixels includes an operation of performing cross-pixel manipulation by adjusting the left and right pixels in space coordinates on an x-axis, y-axis and z-axis until the viewer indicates that the image is clear to the viewer.

10. The computer program product as set forth in claim 8, wherein receiving the distance between a viewer and the 3D parallax barrier screen positioned over a device display screen, the one or more processors receive a manually measured input by a user.

11. The computer program product as set forth in claim 8, wherein receiving the distance between a viewer and the 3D parallax barrier screen positioned over a device display screen, the one or more processors perform a distance calculation using readings from a sensor attached to the display device.

12. A computer implemented method for three-dimensional (3D) space vision correction prescription for displays, the method comprising an act of:
causing one or more processers to execute instructions encoded on a non-transitory computer-readable medium, such that upon execution, the one or more processors perform operations of:
receiving a distance between a viewer and a 3D parallax barrier screen positioned over a device display screen, the 3D parallax barrier screen having an opaque layer with a series of slits formed therethrough;
displaying an image on the device display screen, the device display screen having a pixel layer with a plurality of left and right eye pixels, with the image being displayed by the left and right eye pixels such that the left and right eye pixels are viewable by the viewer through the slits in the 3D parallax barrier screen; and
altering the image as displayed by the left and right pixels until the viewer indicates that the image is clear to the viewer, thereby performing image correction simulation.

13. The method as set forth in claim 12, wherein altering the image as displayed by the left and right pixels includes an operation of performing cross-pixel manipulation by adjusting the left and right pixels in space coordinates on an x-axis, y-axis and z-axis until the viewer indicates that the image is clear to the viewer.

14. The method as set forth in claim 12, wherein receiving the distance between a viewer and the 3D parallax barrier screen positioned over a device display screen, the one or more processors receive a manually measured input by a user.

15. The method as set forth in claim 12, wherein receiving the distance between a viewer and the 3D parallax barrier screen positioned over a device display screen, the one or more processors perform a distance calculation using readings from a sensor attached to the display device.

16. A method for three-dimensional (3D) space vision correction prescription for displays, the method comprising acts of:
positioning a three-dimensional (3D) parallax barrier screen over a device display screen, the 3D parallax barrier screen having an opaque layer with a series of slits formed therethrough;
causing one or more processers to execute instructions encoded on a non-transitory computer-readable medium, such that upon execution, the one or more processors perform operations of:
receiving a distance between a viewer and the 3D parallax barrier screen positioned over the device display screen;
displaying an image on the device display screen, the device display screen having a pixel layer with a plurality of left and right eye pixels, with the image being displayed by the left and right eye pixels such that the left and right eye pixels are viewable by the viewer through the slits in the 3D parallax barrier screen; and
altering the image as displayed by the left and right pixels until the viewer indicates that the image is clear to the viewer, thereby performing image correction simulation.

17. The method as set forth in claim 16, wherein altering the image as displayed by the left and right pixels includes an operation of performing cross-pixel manipulation by adjusting the left and right pixels in space coordinates on an x-axis, y-axis and z-axis until the viewer indicates that the image is clear to the viewer.

18. The method as set forth in claim 16, wherein receiving the distance between a viewer and the 3D parallax barrier screen positioned over a device display screen, the one or more processors receive a manually measured input by a user.

19. The method as set forth in claim 16, wherein receiving the distance between a viewer and the 3D parallax barrier screen positioned over a device display screen, the one or more processors perform a distance calculation using readings from a sensor attached to the display device.
